(19) United States
(12) Patent Application Publication
(10) Pub. No.: US 2008/0277584 A1
(43) Pub. Date: Nov. 13, 2008

(54) Method for Changing Energy of Electron Beam in Electron Column

(76) Inventor: Ho Seob Kim, Incheon (KR)

Correspondence Address: PARK LAW FIRM, 3255 WILSHIRE BLVD, SUITE 1110, LOS ANGELES, CA, 90010, US

(21) Appl. No.: 12/064,076

(22) PCT Filed: Aug. 18, 2006
(86) PCT No.: PCT/KR2006/003264

§ 371 Date: Feb. 18, 2008

(30) Foreign Application Priority Data
Aug. 18, 2005 (KR) 10-2005-0075540

(51) Int. Cl. G01N 23/00

(52) U.S. Cl. 250/311

(57) ABSTRACT

The present invention relates to a method of effectively changing the energy of an electron beam in an electron column for generating an electron beam. This includes the step of additionally applying voltage to an electrode such that the electron beam finally has the desired energy so as to freely control the energy when the electron beam reaches a sample.

### TECHNICAL FIELD

The present invention relates to a method of efficiently changing the energy of an electron beam in an electron column.

### BACKGROUND ART

Changing the energy of the electron beam in an electron column is a very important function for its usage. For example, when lithography is performed using an electron column, when an electron beam is used for display, or when an electron column is used as an electron microscope, the energy of an electron beam, which reaches a sample, affects the penetration depth to which the electron beam is incident into a sample, the damage to the sample, and the resolution.

The energy of an electron beam reaching a sample depends on the voltage applied to an electron emission source emitting electrons in an electron column. Though in a column with a very small and fine structure like a micro-column—the maximal possible voltage applied to the electron emission source in order to increase the energy of the electron beam in the micro-column is limited. With respect to a micro-column, an example of the structure of a single micro column is disclosed in Korean Patent Application No. 2003-66003.

Related papers include a paper entitled “An electron-beam microcolumn with improved resolution, beam current, and stability” published in 1995 (J. Vac Sci. Technol. B 13(6), pp. 2498-2503) by Crashmer et. al. and a paper entitled “Experimental evaluation of a 20×20 mm footprint microcolumn” published in 1996 (J. Vac Sci. Technol. B 14(6), pp. 3792-3796). Related foreign patents include U.S. Pat. Nos. 6,297,584, 6,281,508, and 6,195,214. Furthermore, a multi-microcolumn may be formed of a Single Column Module (SCM) constructed by arranging a plurality of single micro-columns in series or in parallel. It might also be formed of two or more standardized Monolithic Column Modules (MCMs)—that is a set of 2×1 or 2×2 modules—or may be constructed using a Wafer-scale Column Module (WCH), in which a single wafer constitutes a lens part of the column. Such a basic principle is disclosed in a paper entitled “Electron-beam microcolumns for lithography and related applications” published in 1996 (J. Vac Sci. Technol. B14, pp. 3774-3781) by H. P. Ching et. al. Another scheme is a mixed and multi-type scheme in which one or more columns are arranged along with an SCM, an MCM, or a WCM, or some column lens parts are constructed in the form of an SCM, MCM or WCM. Related experimental results of this scheme are disclosed in a paper entitled “Multi-beam microcolumns based on arrayed SCM and WCM” published in 1994 (Journal of the Korean Physical Society 45(5), pp 1214-1217) by Hosup Kim et. al. and a paper entitled “Arrayed microcolumn operation with a wafer-scale Einzel lens” published in 1995 (Microelectronic Engineering pp 78-79 and 55-61) by Hosub Kim et. al.

In an electron column, the distance between an electron emission source and the first electrode—for example an extractor—is about 100 mm. A negative voltage between hundreds of V and 1 kV is applied to the electron emission source and ground voltage (0 V) is applied to the electrode. As the applied voltage increases, more electrons are emitted. With increasing voltage, however the electron beam becomes unstable and in the worst case the electron emission source can break.

In order to resolve such damage to the electron emission source, a method to maint an ultra-high vacuum around the electron emission source or a method to apply a low voltage difference between the electron emission source and the first electrode (extractor or lens layer) may be used. The maintenance of the ultra-high vacuum however entails difficulties in the light of cost and structure, and the use of the voltage difference has a limitation in the applicable voltage.

### DISCLOSURE OF INVENTION

### Technical Problem

The present invention has been made keeping the above problems in mind. An object of the present invention is to provide a method of floating the last electrode (lens layer or focus lens) above a sample to freely control the energy of an electron beam while using a low voltage difference between the electron emission source and the first electrode in an electron column.

### Technical Solution

In order to accomplish the above object, a method of changing the energy of an electron beam is proposed by applying voltage to a corresponding electrode such that the electron beam finally has desired energy so as to freely control the energy when the electron beam reaches a sample.

According to the present invention, a voltage is applied to an electron emission source of an electron column to ensure a stable working condition. This induces the electron emission source to emit an electron beam with a constant beam energy. For free control of the beam energy at the sample, voltages are applied to the first, second and third layer of a lens (generally a focus lens) directly above the sample. Voltages applied to the second lens layer (to perform focusing) are changed as well.

In this method, an electrode is not required between the last layer of the focus lens and the sample but may be added. However, in respect to the complicated structure of an electron column and the electron beam control, it is most preferable to float a focus lens.

In order to observe a sample using an electron column, and a device for detecting secondary electrons and/or Back-Scattering Electrons (BSE) such as an SE-detector, a MCP, a BSE-detector or a semiconductor detector—are required. Such a detector is provided with high voltage, or emits electrons in a ground state, so that it is possible to change the energy of an electron beam. If an electron detector is positioned sideways to an electron column, it only slightly affects the energy of an electron beam. If the position of the electron detector is close to the electron column or in direction of the electron column, it can greatly affect the energy of the electron beam. For lithography, the detector can be positioned to the side of the electron beam axis, thereby only slightly affecting the energy of the electron beam. In this case, voltage applied to the focus lens is also applied to the detector, so that the voltages of focus lens and detector are identical or similar. For this case an additional electronic control device may be required.

### ADVANTAGEOUS EFFECTS

If the method of changing the energy of an electron beam in an electron column according to the present invention is used, the energy of the electron beam can be controlled appropriately without applying high voltage to the electron emission source. This leads to a reduced load of the tip of an electron emission source and reduces the cost of maintaining the ultra-high vacuum state.

If the method of changing the energy of an electron beam in an electron column according to the present invention is used, the energy of the electron beam is increased by applying voltage to the focus lens, thereby improving the resolution of the electron column.

### BRIEF DESCRIPTION OF THE DRAWINGS

FIG. 1 is a sectional view schematically illustrating a method of changing the energy of an electron beam in an electron column according to the present invention;

FIG. 2 is a sectional view schematically illustrating another method of changing the energy of an electron beam in an electron column according to the present invention;

FIG. 3 is a sectional view schematically illustrating still another method of changing the energy of an electron beam in an electron column according to the present invention; and

FIG. 4 is a sectional view schematically illustrating still another method of changing the energy of an electron beam in an electron column according to the present invention.

### MODE FOR THE INVENTION

Embodiments of the present invention are described below in detail with reference to the drawings.

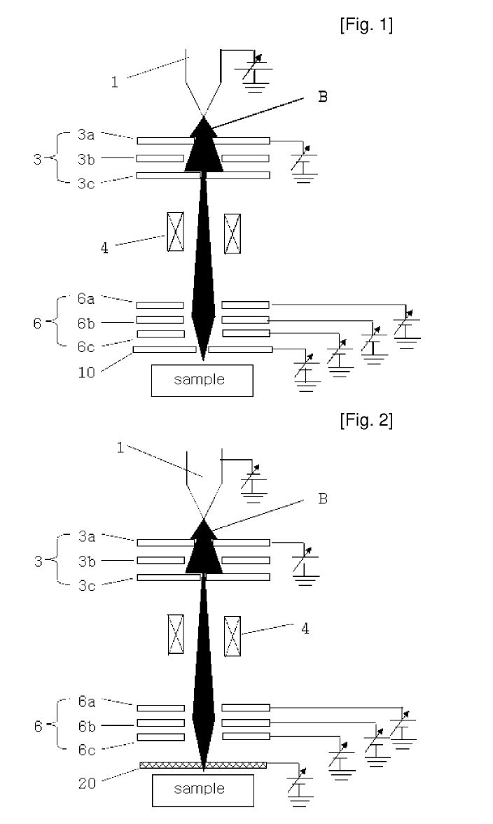

FIG. 1 shows an embodiment of a method to control an electron beam according to the present invention. It is a sectional view illustrating the control of the electron beam inside a general electron column.

If a negative voltage between some hundred volts to one kilo Volt is applied to an electron emission source 1, which is higher than the voltage applied to the extractor lens layer 3a of a source lens 3, electrons are emitted from the electron emission source. If necessary, electrons are caused to be emitted from the electron emission source 1 in such a way that a voltage of −500 eV is applied to the electron emission source 1, and higher voltage (for example, −200 eV to +200 eV) is applied to the extractor 3a. The emitted electrons from an electron beam B are accelerated by an accelerator 3b and then focused by a limiting aperture 3c. If required, voltage may be applied to respective lens layers, but generally ground voltage is applied to lenses 3a and 3c.

After the electron beam passed the limiting aperture 3c, it is deflected by a deflector 4 and then focused onto a sample by a focus lens 6. Secondary electrons and electrons which are reflected from the sample are detected by a detector (not shown). The detector results can be visualized in form of an image. In this case, the detector may be located coaxial to the lenses, separate therefrom, or located in various methods depending on the characteristics thereof.

Although in the present invention the detector is located along the beam axis to the lenses, it may also be located on the side of the electron beam.

The energy of the electron beam reaching the sample is determined by the voltage difference between the electron emission source 1 and the last lens layer 6c of the electron column or the sample. Usually the last lens layer 6c is grounded (0V). However, in FIG. 1, in order to apply a higher voltage, a separate lens layer or an electrode layer 10 may be arranged to the lower part of the focus lens 6 along with or separately from the detector. Of course, the electrode layer 10 is used in the case where the electron beam is provided with more energy, or close to the sample to increases and changes energy, with respect to the voltage applied to the last layer (for example, 6c) of the lens. Depending on the need, the determination of whether to use it may be made.

If negative voltage within a range of hundreds of eV to 2 keV is applied to the electron emission source, the energy of the electron beam increases when a positive voltage of 0V or more is applied to the last lens layer or the electrode.

In FIG. 1, voltage can be separately applied to the three lens layers 6a, 6b and 6c of a focus lens 6. The energy of the electron beam is finally changed by the electrode 10 for changing the electron beam energy, such as one electrode layer 3a, 3b, 3c, 6a, 6b, or 6c of a source lens 3 and the focus lens 6, to which voltage can be applied. After the required voltage at electrode 10 has been calculated, the voltage is applied to the electrode layer 10. If the electrode layer 10 is not used, the voltage required for the focus lens 6 is calculated and applied. In this case voltage may be applied to respective lens layers 6a, 6b and 6c of the focus lens 6, or may be applied to the last lens layer 6c. However, applying the additional voltage to the entire focus lens is preferable to changing the energy of the electron beam.

In FIG. 2, the detector 20, which may or may not include the electron beam energy change electrode layer, is located coaxial to the lens at the location of the electrode layer 10. The voltage is applied as described in the above-described electrode layer for changing electron beam energy. If the voltage for detection is applied to the detector 20, the required voltage is calculated as in the focus lens 6 and is applied (occasionally, the voltage increases or decreases). In FIG. 2, voltage may be applied only to the last layer 6c of the focus lens (in this case only detector 20 is used), but voltage can be applied to the detector 20 in the method of separately or collectively applying voltage to respective layers of the focus lens in FIG. 1.

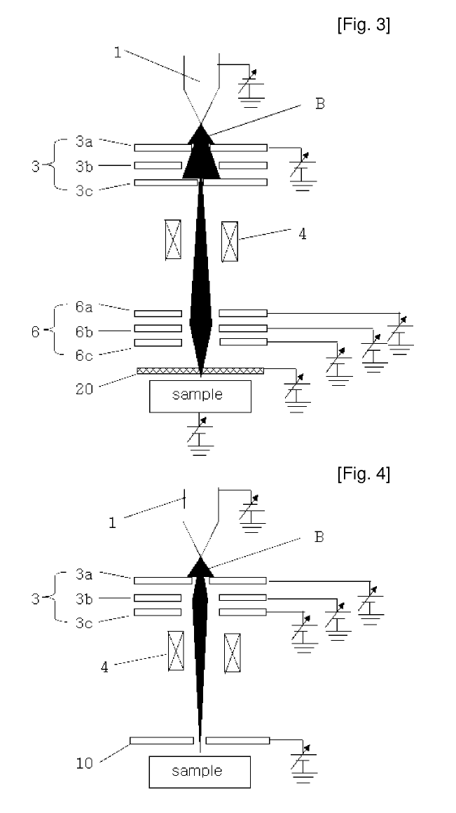

FIG. 3 shows another embodiment of the present invention. A separate voltage is applied to the sample. The final energy of the electron beam is determined by the voltage difference between the electron emission source and the sample. In this case, it is possible to additionally apply voltage to the focus lens 6 and sample and also to apply required voltage only to the sample without applying voltage to the foucs lens 6, thereby changing the energy of the electron beam which reaches the sample.

In the eletron column having the simplest structure according to the present invention (FIG. 4), there is no separate focus lens part. The required voltage for extracting and foucsing is applied to the source lens. If an energy increase is required, voltage is applied to all of the parts 3a, 3b and 3c of the source lens or a required layer 3b and/or layer 3c. In this case, it is possible to increase the voltage required by the deflector. However, an easier method is to apply the voltage to the electron energy change electrode layer 10, thereby finally changing the energy.

Although a single-type electron column has been described, a multiple-type electron column can control the energy of an electron beam in the same way.

For the multiple-type electron column—unit electron columns, which each correspond to a single-type electron column—are arranged in a n×m matrix and then used. Voltage is applied to an added electrode or lens (layer) in addition to an existing control method, and an electrode added to control the energy of an electron beam is controlled in the method of controlling a conventional multi-column.

In the above description of the embodiment, the sample of FIG. 3 could be connected to a power supply in order to apply separate voltage, but in the examples of FIGS. 1, 2 and 4, each sample is grounded or floated. If the sample is grounded, the energy of the electron beam results as the voltage difference between the voltage, applied to the electron emission source, and the voltage of the sample. Therefore, when the electrode 10 is used with the interval between the electrode and the sample minimized, for example, to several micrometers, the energy of the electron beam can be changed by voltage additionally applied to the electrode 10, and resolution is also improved depending on the increasing of the beam energy.

### INDUSTRIAL APPLICABILITY

The method of changing the energy of an electron beam according to the present invention can be applied to an inspection device or lithography device using an electron column. Furthermore, the multi-electron column can be applied to an inspection device or lithography device using an electron column.

1-5. (canceled)

6. A method of changing energy of an electron beam of an electron column, comprising the step of additionally applying voltage to an electrode such that the electron beam finally has desired energy so as to freely control energy thereof when the electron beam reaches a sample.

7. The method as set forth in claim 6, wherein the electrode is a focus lens.

8. The method as set forth in claim 6, wherein the electrode is a separate dedicated electrode or a detector for controlling the energy of the electron beam.

9. The method as set forth in claim 8, wherein voltage applied to the detector is identical to voltage applied to the focus lens, or is a ground voltage.

10. The method as set forth in claim 6, further comprising the step of additionally applying voltage to the sample.

11. The method as set forth in claim 7, further comprising the step of additionally applying voltage to the sample.

12. The method as set forth in claim 8, further comprising the step of additionally applying voltage to the sample.

13. The method as set forth in claim 9, further comprising the step of additionally applying voltage to the sample.
